(19) United States
(12) Patent Application Publication
(10) Pub. No.: US 2006/0249694 A1
(43) Pub. Date: Nov. 9, 2006

(54) Marking of diamond

(76) Inventors: Herman Philip Godfried, Amsterdam (NL); Daniel James Twitchen, Berkshire (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/543,913

(22) PCT Filed: Jan. 29, 2004
(86) PCT No.: PCT/IB04/00206

§ 371 Date: May 18, 2006

(30) Foreign Application Priority Data
Jan. 30, 2003 (GB) 0302216.7

(51) Int. Cl. B23K 15/00; G21G 5/00

(52) U.S. Cl. 250/492.1; 219/121.12

(57) ABSTRACT

A method of marking or coloring a diamond article, such as a surgical blade, wire die, diamond anvil, laser window, or the like, to generate a reference mark that may subsequently be modified, reduced or removed by an annealing technique. The method of coloring uses particles such as electrons, ions, neutrons, or gammas, which are preferably of high energy, and preferably in a form of a controlled beam. The treatment is such that the particles or beam used in the treatment cause local damage or defect centers in the material, such defect centers then generating the desired color or mark.

### BACKGROUND OF THE INVENTION

THIS invention relates to a method of reversibly marking diamond articles.

Diamond offers a range of unique properties, including optical transmission, thermal conductivity, stiffness, wear resistance and electronic properties. Accordingly, it can be used in a wide range of applications utilising its unique properties. The use of diamond, however, is relatively costly and the diamond products therefore have relatively high value. In certain applications it is possible to refurbish the diamond product, which is obviously desirable. This refurbishment may, however, change or affect certain of its properties or other characteristics.

In the manufacture of diamond products it is also often useful to mark the products to show, for example, product specification including size specification, processing history, current grade, type of cutting edge applied, and the like. Current marking systems include, for example, laser scribing, which is not effective in certain applications as it may negatively affect the strength of the component. Further, conventional marking systems are not readily reversible, hence they are also not particularly useful in application where the products have been refurbished and certain of their characteristics have been affected or changed as a consequence.

By way of example, diamond has successfully been used since the early 1970's as the ultimate material for surgical scalpels. Its hardness, strength and perfect crystalline nature allow the manufacture of cutting edges that are defect free under microscopic examination at for instance 100× magnification. Surgical instruments equipped with diamond scalpels outperform steel scalpels by lowering cutting resistance and creating less deformation of the tissue being cut thus allowing better precision in the operation. In addition, less tissue damage during the cutting operation results in much faster healing of the wound.

The relatively high price of natural diamond and the associated cost of processing this ultra-hard material meant that this application was limited to certain market segments.

Advances in recent years in the synthesis of polycrystalline diamond films at significantly lower cost than natural diamond has resulted in an increase in the use of diamond for making surgical blades, albeit that they are still regarded as having a relatively high value.

A problem with using diamond surgical blades, however, is that to date they have not successfully been marked, such as to provide a ‘depth of cut’ marker on a scalpel or diamond knife. Although the benefits of marking surgical blades are well known since disposable steel surgical blades are marked, no such marking system for diamond is currently in commercial use in the field of blades. Surface markings to diamond are unstable in application and may be a source of contamination, whereas marks within the body of the device, such as laser cuts, are permanent or require processes such as polishing to remove. This is particularly a problem where the edge or shape of the surgical blade is reprocessed, rendering the marking inappropriate.

Additionally, diamond free from defects is a transparent material. Whilst this may be advantageous in some applications, for a surgical cutting edge it is often advantageous to improve the visibility of the edge by providing the diamond with some colour. Colour can be obtained in synthetic diamond by uniform doping, for example using B, but such processes need to be applied during synthesis which is not always desirable. Coloured natural diamond is not normally sufficiently strongly coloured, and is generally excluded from commercial applications on the basis of cost.

There is therefore a requirement for a practical marking system for, in particular, reversibly marking diamond articles.

### SUMMARY OF THE INVENTION

According to the invention, a method of marking a diamond article includes the steps of:
(1) providing a diamond body;
(2) shaping the diamond body into a desired shape for the diamond article; and
(3) creating at least one indicia in the diamond body or colouring the diamond body or a portion thereof, which indicia or colouring may be modified, reduced or removed.

The indicia and/or colouring of the diamond body or a portion thereof are typically created by treatment using particles such as electrons, ions, neutrons, or gammas, preferably using electrons, neutrons or gammas, more preferably using electrons or gammas, and even more preferably using electrons. The particles used are preferably of high energy, and preferably in the form of a controlled beam. The treatment is such that the particles or beam used in the treatment cause local damage or defect centres in the material, such defect centers then generating the desired colour. For the purposes of this specification, such treatment as described above will be referred to as the colouring treatment.

The nature of the defects generated by the colouring treatment is such that they may be modified or removed by annealing, modifying or removing the associated colour generated in the diamond. This is particularly the case when the damage was initially caused by electrons, neutrons or gammas, or by using carbon atoms. Thus the indicia or colouring may be removed by annealing, optionally combined with further colouring treatment.

The indicia may be a reference mark, a design code, brand mark or other symbolic marking on the article.

The diamond article may be, for example, an insert for a surgical implement, an ultra-microtome knife, a wire die, a diamond anvil, or a laser window.

In one embodiment of the invention, the insert is a surgical blade, the implement being a scalpel, a surgical knife, or a similar surgical instrument.

Except where discrete marking is intended, the colouring of the diamond body is preferably generally uniform, to provide enhanced visual recognition to the edge and the shape of the blade.

The surgical blade is preferably shaped to a point or tip, reference marks being generated by the colouring treatment at an appropriate distance from the tip to provide a depth of cut marker for the blade.

In one version of this embodiment of the invention, the entire tip is coloured using the colouring treatment to a line a given distance from the tip, the coloured region having a boundary along the line, which boundary defines the reference mark.

In an alternative version of this embodiment of the invention, a distinctive line is generated in the body using the colouring treatment a given distance from the tip, which line defines the reference mark.

The invention extends to a method of reprocessing a diamond article having one or more existing indicia or general colouring generated by a marking method of the invention, the method including the steps of:
(i) reshaping the diamond body or a portion thereof to the desired shape; and either
(ii)(a) removing the existing marks generated by annealing and/or using a colouring treatment as defined above to generate one or more new marks or modify an area of colouring; or
(ii)(b) reducing or modifying the existing marks and/or colouring so that they blend into the background colour of the diamond, and then further using a colouring treatment as defined above to generate one or more new marks or general colouring; or
(ii)(c) in the case of an existing region of colour, whose boundary defines a reference mark, extending the region by further application of a colouring treatment as defined above such that the new boundary of the region defines the reference mark.

Those skilled in the art will recognize that the exact order in which these component steps given above takes place can be varied, for example the remarking of the diamond can precede the reshaping and form part of the method by which reshaping is controlled.

### DESCRIPTION OF EMBODIMENTS

The crux of the invention is to provide a method of marking or colouring a diamond article, such as a surgical blade, wire die, diamond anvil, laser window, or the like, to generate a reference mark which may subsequently be modified, reduced or removed by an annealing technique. The method of colouring provided is the treatment using particles such as electrons, ions, neutrons, or gammas, preferably using electrons, neutrons or gammas, more preferably using electrons or gammas, and even more preferably using electrons. The particles used are preferably of high energy, and preferably in the form of a controlled beam. The treatment is such that the particles or beam used in the treatment cause local damage or defect centres in the material, such defect centres then generating the desired colour or mark.

It is known that exposure to particle or other beams, particularly where those beams are of high energy, can be used on diamond to generate colour locally. In particular, the use of high energy electrons, ions, neutrons and gammas is known to generate such effect. It has thus been found that such techniques can be used to provide or create an indicia, typically in the form of a reference mark, a design code, brand mark or any other appropriate symbolic marking, in a diamond article, or to colour the diamond article, for example. It is also known that the modification of bulk colours in diamond, whether present initially or from treatment by high energy particles, may be modified by annealing treatment, which is also useful in the present invention.

For convenience, the method will be described with reference to the use of the colouring treatment to generate a reference mark, but can obviously be used for any other kind of marking or colouring. The first step in the process is to provide an appropriate diamond body with the required diamond composition (i.e. impurities) and initial colour using selection (in the case of natural diamond) or synthesis (in the case of CVD or HPHT diamond) techniques. The diamond body is then fabricated into the appropriate diamond article, such as a surgical blade.

Whilst the invention extends to the marking of various diamond articles it will, in what follows in the most part, be described with reference to the marking of a diamond surgical blade for convenience.

If necessary, the bulk colour of the diamond may be modified. This is particularly carried out where it is important to provide enhanced visual recognition to the edge and the shape of the blade. The generation of a more strongly coloured local mark or region in the bulk or near a surface region of the diamond is carried out using the colouring treatment.

Control of the pattern of the colouring generated by the colouring treatment can be achieved in a variety of ways. A simple technique is to place a mask in the path of the particles or beam being used for the colouring treatment, the local density of the mask determining the degree to which the diamond underneath is exposed to the action of the colouring treatment.

This technique would allow the simultaneous generation of a uniform background colour together with fiducial and symbolic markings. The advantage of this technique is that bulk processing techniques can be used. Alternatively, the colouring treatment can be by directed beam, which directly writes the desired features into the diamond.

Following the use and reprocessing of the shape or edge of the surgical blade, the reference mark may be modified or reduced to blend into the weaker background colour of the diamond, or may be removed entirely, by using an appropriate annealing technique, optionally combined with further colouring treatment. Modification may consist of the extension of the strongly coloured region such that the boundary of the region to the background colour marks the point of interest. Substantial removal of the mark may be assisted by further colouring treatment which would preferably be uniform over the sample to enhance bulk processability, so that further marking can then take place unimpeded by the previous use.

Thus at each stage in the process, the colour and condition of the diamond is optimised to enable the reversible or modifiable marking system to operate, optionally in combination with a beneficial weaker background colour. The background colour need not be identical following each re-marking cycle although a similar colour would be preferable. The only requirements are that the newly applied strongly coloured marking be sufficiently distinct for the application, that the old markings which are no longer required cannot be confused for the new marking and preferably do not make the previous point of interest easy to discern, and that the background colour does not substantially interfere with the application and preferably assists by defining the general form of the insert.

Further advantages include the fact that, whilst writing the marks may be a piece by piece process, depending on the specific method used, the removal of the marks would generally be a bulk process.

A particular advantage of the marking system is that it does not affect the strength of the component, as laser scribing would do, for instance.

Whilst the invention is applicable to all forms of diamond, it is particularly suited to synthetic diamond, and more particularly to CVD synthetic diamond, since this type of diamond offers a more reproducible engineering material for the applications in which marking is generally advantageous. The method may be used on both polycrystalline CVD diamond and single crystal CVD diamond, although more care may be required in the case of polycrystalline diamond during annealing to remove marks, in order to avoid deleterious degradation of the general diamond structure by, for example, grain boundary graphitisation which can occur if the annealing temperature is excessive.

As mentioned previously, the marking system of the invention is applicable to a wide range of diamond products. These include, for example, the following:
i) Ultra-microtome knives—these are returned for resharpening or removal of edge chips. These may be marked to trace individual item, processing history, current grade or type of cutting edge applied, and the like;
ii) Wire dies—these may be reprocessed to larger hole sizes as wear occurs and thus would need remarking with the new specification;
iii) Diamond anvils—these may be reprocessed to remove damage and the product specification code may need changing accordingly;
iv) Laser windows—these may be damaged by combined chemical/optical etching or by spattered material impinging on the window (from laser cutting) and may thus need repolishing.

Reversible marking can be used for example to record the optical thickness of the window which can critically affect issues such as optical reflection losses.

The invention will now be described, by way of example only, with reference to the following non-limiting examples.

### EXAMPLE 1

a) A CVD diamond layer was grown to be essentially colourless.
b) The CVD diamond layer was then shaped into a surgical blade comprising a rectangular plate with one of the shorter sides then shaped into a point on the centre line with symmetric sloping sides, and the sides polished at an angle with respect to the plane of the plate to form cutting edges.
c) A boundary was defined in the diamond by using a high energy electron beam to colour the whole of the tip of the diamond blade back to a line a given distance from the tip which was perpendicular to the longer sides of the original rectangle. The conditions of the colouring treatment used were a dose of 4×10¹⁸ electrons/cm² at an energy of 1.5 MeV, which formed a deep blue colour in the diamond.
d) After use and resharpening, such that the length of the cutting tip beyond the original boundary marked above had changed, the boundary was remarked by further use of the colouring treatment, using the same conditions, over the whole of the tip of the diamond blade back to a line a given distance from the tip which was perpendicular to the longer sides of the original rectangle, this new boundary being formed in the uncoloured diamond behind the original boundary. As the colour generated by the colouring treatment was fairly intense, the old boundary was barely visible. The colour of the diamond tip was also of assistance in the application, providing clear visual recognition of the tip.

### EXAMPLE 2

a) A CVD diamond layer was grown to be essentially colourless.
b) The CVD diamond layer was then shaped into a surgical blade comprising a rectangular plate with one of the shorter sides then shaped into a point on the centre line with symmetric sloping sides, and the sides polished at an angle with respect to the plane of the plate to form cutting edges.
c) A boundary was defined in the diamond by using the colouring treatment to colour a line across the diamond blade back a measured distance from the tip and perpendicular to the longer sides of the original rectangle. The conditions of the colouring treatment used were a dose of 4×10¹⁸ electrons/cm² at an energy of 1.5 MeV, which formed a deep blue colour in the diamond.
d) After use and resharpening, such that the length of the cutting tip beyond the original mark above had changed, the sample was annealed at. 1400° C. for 4 hours, which reduced the mark to essentially colourless. A new mark was then generated by further application of the colouring treatment using the same conditions in the correct location for further use.

1-19. (canceled)

20. A method of marking a diamond article comprising:
(1) providing a diamond body;
(2) shaping the diamond body into a desired shape for the diamond article; and
(3) creating at least one indicia in the diamond body or coloring the diamond body or a portion thereof, which indicia or coloring may be modified, reduced or removed.

21. A method according to claim 20, wherein the indicia and/or coloring of the diamond body or a portion thereof are created by a coloring treatment using particles selected from the group of electrons, ions, neutrons, and gammas.

22. A method according to claim 21, wherein the particles used are of high energy.

23. A method according to claim 21, wherein the particles are in a form of a controlled beam.

24. A method according to claim 21, wherein the coloring is such that the particles or beam used in the coloring cause local damage or defect centers in the material, such defect centers generating the desired color.

25. A method according to claim 21, wherein the defects generated by the coloring may be modified or removed by annealing, modifying or removing the associated color generated in the diamond.

26. A method according to claim 20, wherein the indicia is a reference mark, a design code, brand mark or other symbolic marking on the article.

27. A method according to claim 20, wherein the diamond is produced by chemical vapor deposition.

28. A method according to claim 27, wherein the diamond is single crystal diamond

29. A method according to claim 27, wherein the diamond is polycrystalline diamond.

30. A method according to claim 20, wherein the diamond article is selected from the group of an insert for a surgical implement, an ultra-microtome knife, a wire die, a diamond anvil, or a laser window.

31. A method according to claim 30, wherein the insert is a surgical blade, the surgical implement being a scalpel or a surgical knife.

32. A method according to claim 31, wherein the coloring of the diamond body is generally uniform, to provide enhanced visual recognition to an edge and shape of the blade.

33. A method according to claim 31, wherein the surgical blade is shaped to a point or tip, reference marks being generated by the coloring treatment at an appropriate distance from the tip to provide a depth of cut marker for the blade.

34. A method according to claim 33, wherein the entire tip is colored using the coloring treatment to a line a given distance from the tip, the colored region having a boundary along the line, which boundary defines the reference mark.

35. A method according to claim 33, wherein a distinctive line is generated in the body using the coloring a given distance from the tip, which line defines the reference mark.

36. A method of reprocessing a diamond article having one or more existing indicia or general coloring generated by a marking method according to claim 20, the method comprising:
(i) reshaping the diamond body or a portion thereof to a desired shape; and one of
(ii)(a) removing the existing marks generated by annealing and/or using a coloring treatment to generate one or more new marks or modify an area of coloring; or
(ii)(b) reducing or modifying the existing marks and/or coloring so that they blend into a background color of the diamond, and then further using a coloring treatment to generate one or more new marks or general coloring; or
(ii)(c) in a case of an existing region of color, whose boundary defines a reference mark, extending the region by further application of a coloring such that the new boundary of the region defines the reference mark.
